(19) United States
(12) Patent Application Publication
(10) Pub. No.: US 2015/0043839 A1
(43) Pub. Date: Feb. 12, 2015

(54) Protective Shield for Controller Device

(71) Applicant: Page K. Douthat, Greenville, TN (US)

(72) Inventor: Page K. Douthat, Greenville, TN (US)

(21) Appl. No.: 14/457,584

(22) Filed: Aug. 12, 2014

Related U.S. Application Data
(60) Provisional application No. 61/864,842, filed on Aug. 12, 2013.

(51) Int. Cl. H01H 9/02; B65D 33/20

(52) U.S. Cl. CPC H01H 9/0242; B65D 33/20
USPC 383/42

(57) ABSTRACT

A protective enclosure for protecting a hand-held controller device and user having a device shape includes a shield including: a sheath or shield forming a sheath pocket having a top and a bottom made of a flexible, resilient material that blocks contaminants from reaching the hand-held controller device and user, and wherein the hand-held controller device is disposed inside the sheath pocket: a passage through an open end of the sheath that facilitates insertion of the hand-held controller device inside the sheath pocket, the open edge defining bottom passage edge and a top passage edge; and a sealing device that closes the passage after the hand-held controller device has been inserted into the sheath portion; wherein the sealing device is disposed on the bottom passage edge and the sealing device having an adhesive material provided thereon for sealing with the top passage.

### CROSS-REFERENCE TO RELATED APPLICATIONS

This application claims the benefit of U.S. Provisional Patent Application Ser. No. 61/864,842, filed Aug. 12, 2013, the entirety of which is incorporated herein by reference.

### FIELD OF INVENTION

The present application is directed to protective enclosures for housing hand-held controller devices during use, particularly when the device contains keypad components which remain extremely difficult to clean.

### BACKGROUND

Many facilities such as hotels and hospitals require a process to sanitize of surfaces and devices utilized by customers or patients to minimize the spread of infectious diseases. A multitude of hand-held auxiliary devices may require covering with a clean sheath when the device is utilized to remotely control another unit or device, such as a television. These devices are sometimes referred to as remotes or remote controllers.

Efforts regarding such systems have led to continuing developments that improve their functionality, versatility, practicality and efficiency.

### BRIEF SUMMARY

Disclosed herein are various embodiments of a protective enclosure to enhance safety from bioburden while using a hand-held controller device. Generally, example embodiments include a shield, which encompasses: a sheath or shield forming a sheath pocket having a top and a bottom made of a flexible, resilient material that blocks contaminants from reaching the user of the hand-held controller device, wherein the hand-held controller device is disposed inside the sheath pocket. A passage through an open end of the sheath facilitates insertion of the hand-held controller device inside the sheath pocket, the open edge defining bottom passage edge and a top passage edge, the top passage edge having a permadhesive closure. A sealing device closes the passage after the hand-held controller device has been inserted into the sheath portion. In some embodiments, the sealing device is disposed on the bottom passage edge and the sealing device having an adhesive material provided thereon for sealing with the top passage. In some embodiments, the sealing device encompasses a flap formed from a portion of the sheath; this flap folds over and makes contact with another portion of the sheath on the opposite passage edge, thereby covering and closing the passage.

Some example embodiments of the present general inventive concept encompass an enclosure for protecting users from contaminants to which users would otherwise be exposed while using a hand-held controller device. Such an enclosure includes a shield including a sheath forming a sheath pocket having a top, a bottom, an open end and a closed end made of a flexible, resilient material that blocks contaminants from reaching the hand-held controller device and user, and wherein the hand-held controller device is disposed inside the sheath pocket, a passage through the open end of the sheath to facilitate insertion of the hand-held controller device inside the sheath pocket, the open edge defining a bottom passage edge and a top passage edge, and a sealing device that closes the passage after the hand-held controller device has been inserted into the sheath portion, wherein the sealing device is disposed on the bottom passage edge for sealing with the top passage edge.

Such protective enclosures and shields for controller devices are useful, for example, in the hotel industry, where the use of such devices and materials according to the present general inventive concept can help to minimize cross-guest contamination.

In some example embodiments of the present general inventive concept, a protective enclosure for protecting a hand-held controller device having a device shape includes a shield encompasses a sheath or shield forming a sheath pocket having a top and a bottom made of a flexible, resilient material that blocks contaminants from reaching the hand-held controller device, wherein the hand-held controller device is disposed inside the sheath pocket. A passage through an open end of the sheath facilitates insertion of the hand-held controller device inside the sheath pocket, the open edge defining bottom passage edge and a top passage edge, the top passage edge having holes provided therein. A sealing device that closes the passage after the hand-held controller device has been inserted into the sheath portion; wherein the sealing device is disposed on the bottom passage edge and the sealing device having an adhesive material provided thereon for sealing with the top passage, the holes facilitating extrusion of a portion of the adhesive through the holes.

In some example embodiments of the present general inventive concept, an enclosure for protecting a hand-held controller device having a device shape includes a shield including a sheath forming a sheath pocket having a top, a bottom, an open end and a closed end made of a flexible, resilient material that blocks contaminants from reaching the hand-held controller device and user, and wherein the hand-held controller device is disposed inside the sheath pocket, a passage through the open end of the sheath to facilitate insertion of the hand-held controller device inside the sheath pocket, the open edge defining a bottom passage edge and a top passage edge, the top passage edge having holes provided therein, and a sealing device that closes the passage after the hand-held controller device has been inserted into the sheath portion, wherein the sealing device is disposed on the bottom passage edge for sealing with the top passage edge, the holes facilitating extrusion of a portion of an adhesive material through the holes.

In some embodiments, the sealing device includes an adhesive strip having a carrier that is removed or peeled off the adhesive strip to expose the adhesive material disposed on the adhesive strip.

In some embodiments, the adhesive strip resides on a tab that extends from the bottom passage edge, said tab to be folded to bring the adhesive strip into contact with the top passage edge.

In some embodiments, the adhesive material is extruded or pressed through the holes when the top passage edge is pressed against the bottom passage edge after the controller device is inserted into the sheath pouch.

In some embodiments, the adhesive material is extruded or pressed through the holes when the top passage edge is pressed against the bottom passage edge after the controller device is inserted into the sheath pouch, the open end of the sheath is folded over toward the closed end wherein the folded portion of the sheath is pressed onto the top of the sheath and the adhesive material that was extruded through the holes adheres to the top of the sheath

In some embodiments, the folded portion seals the controller device in the sheath pocket.

Some embodiments further include a label disposed on the folded portion to indicate the controller device has been sealed in the sheath pocket.

In some embodiments, the shield is discarded after the controller device is removed for a one time use of the shield.

In some embodiments, the shield protects the controller device from biological contamination.

In some example embodiments of the present general inventive concept, a protective shield for protecting a controller device from biological contamination includes a sheath forming a sheath pocket having a top, a bottom, an open end and a closed end made of a flexible, resilient material that blocks contaminants from reaching the hand-held controller device, wherein the hand-held controller device is disposed inside the sheath pocket, a passage through the open end of the sheath facilitating insertion of the controller device inside the sheath pocket, the open edge defining a bottom passage edge and a top passage edge, the top passage edge having holes provided therein, and a sealing device that closes the passage after the controller device has been inserted into the sheath portion, the sealing device including an adhesive strip having a carrier that is removed or peeled off the adhesive strip to expose the adhesive material disposed on the adhesive strip, wherein the sealing device is disposed on the bottom passage edge for sealing with the top passage edge, the holes facilitating extrusion of a portion of an adhesive material through the holes.

In some embodiments, the adhesive material is extruded or pressed through the holes when the top passage edge is pressed against the bottom passage edge after the controller device is inserted into the sheath pouch.

In some embodiments, the adhesive material is extruded or pressed through the holes when the top passage edge is pressed against the bottom passage edge after the controller device is inserted into the sheath pouch, the open end of the sheath is folded over toward the closed end wherein the folded portion of the sheath is pressed onto the top of the sheath and the adhesive material that was extruded through the holes adheres to the top of the sheath

In some embodiments, the folded portion seals the controller device in the sheath pocket.

Some embodiments further include a label disposed on the folded portion to indicate the controller device has been sealed in the sheath pocket.

In some embodiments, the shield is discarded after the controller device is removed for a one time use of the shield.

### BRIEF DESCRIPTION OF THE DRAWINGS

The following example embodiments are representative of example techniques and structures designed to carry out the objects of the present general inventive concept, but the present general inventive concept is not limited to these example embodiments. In the accompanying drawings and illustrations, the sizes and relative sizes, shapes, and qualities of lines, entities, and regions may be exaggerated for clarity. A wide variety of additional embodiments will be more readily understood and appreciated through the following detailed description of the example embodiments, with reference to the accompanying drawings in which:

FIG. 1 is an exploded isometric view of an example embodiment of a cover and a hand-held controller device or remote;

FIG. 2 is an assembled isometric view of an example example cover and remote;

FIG. 3 is an assembled isometric view of an example embodiment of a cover and remote;

FIG. 4A is an assembled isometric view of an example embodiment of a cover and remote, illustrating the remote within the cover with the top side of the remote showing, with the keys of the keypad visible;

FIG. 4B is an assembled isometric view of the same example embodiment of a cover and remote shown in FIG. 4A, illustrating the remote within the cover with the bottom side of the remote showing;

FIGS. 5A-5C are partial top views of embodiments of an example cover;

FIG. 6 is a top view of an embodiment of an example cover;

FIG. 7 is an exploded isometric view of an example embodiment of a cover and remote, showing an embodiment in which the cover includes a tab;

FIG. 8 is an assembled isometric view of the example embodiment of a cover and remote shown in FIG. 7;

FIG. 9 is an assembled isometric view of the example embodiment of a cover and remote shown in FIG. 7-8, showing the tab being folded;

FIG. 10A is an assembled isometric view of the example embodiment of a cover and remote shown in FIGS. 7-9, illustrating the remote within the cover with the top side of the remote showing, with the keys of the keypad visible; and

FIG. 10B is an assembled isometric view of the example embodiment of a cover and remote shown in FIGS. 7-10A, illustrating the remote within the cover with the bottom side of the remote showing.

### DETAILED DESCRIPTION

Referring now to the drawings, wherein an embodiment of a protective enclosure system 100 is shown and described. It is to be understood that usage of the terms “exemplary,” “embodiment,” or “exemplary embodiment” is for illustrative purposes and that such usage is not intended to be interpreted in a restrictive sense which would exclude other examples or embodiments of practice.

Disclosed herein are various embodiments of a protective enclosure for protecting a hand-held controller device user. Generally, example embodiments include a shield, which encompasses: a sheath or shield forming a sheath pocket having a top and a bottom made of a flexible, resilient material that blocks contaminants from reaching the hand-held controller device, wherein the hand-held controller device is disposed inside the sheath pocket. A passage through an open end of the sheath facilitates insertion of the hand-held controller device inside the sheath pocket, the open edge defining bottom passage edge and a top passage edge, the top passage edge having holes provided therein.

A sealing device closes the passage after the hand-held controller device has been inserted into the sheath portion. In some embodiments, the sealing device includes an adhesive strip having a carrier that is removed or peeled off the adhesive strip to expose the adhesive material disposed on the adhesive strip.

In some embodiments, the adhesive strip resides on a tab that extends from the bottom passage edge, the tab to be folded to bring the adhesive strip into contact with the top passage edge.

In some embodiments, the sealing device is disposed on the bottom passage edge and the sealing device having an adhesive material provided thereon for sealing with the top passage, the holes facilitating extrusion of a portion of the adhesive through the holes. In some embodiments, the sealing device encompasses a flap formed from a portion of the sheath; this flap folds over and makes contact with another portion of the sheath on the opposite passage edge, thereby covering and closing the passage.

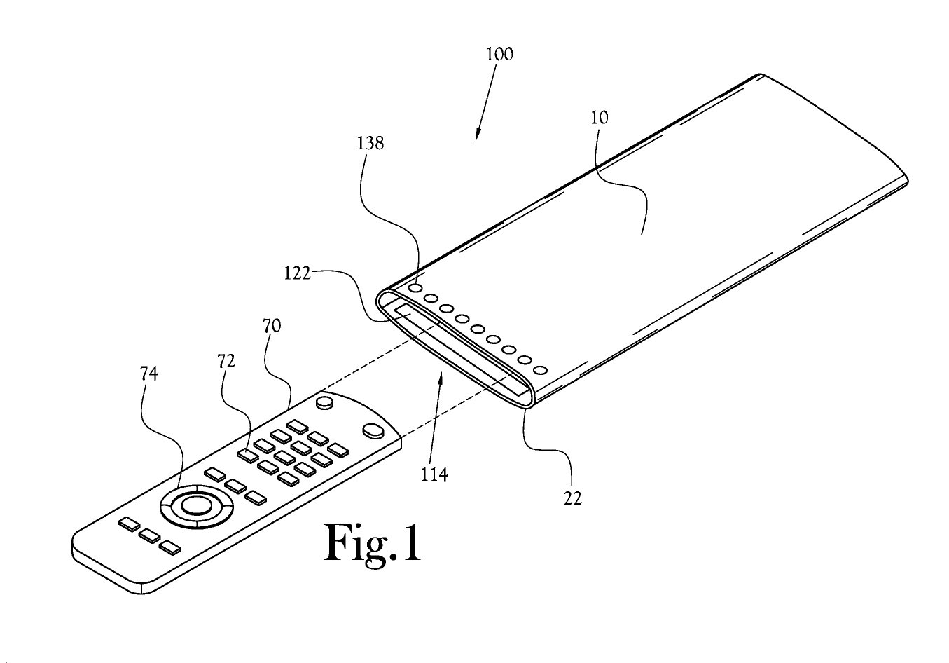

Turning to the Figures and looking first to FIG. 1, a sheath or shield 10 of flexible material is disclosed for covering a hand-held controller device 70 having a plurality of controls 72, 74 thereon which require manipulation by an operator for utilization of the device 70. The sheath 10 is secured along a portion of its perimeter 22 to a carrier 80 as illustrated in FIGS. 1-4B. The sheath 10 is released from the carrier 80 during usage of the controller device 70 therein to provide a protective layer covering the device 70 prior to manipulation by the operator.

In an embodiment, a protective enclosure for protecting a hand-held controller device 70 having a device shape comprising a shield including: a sheath or shield 10 forming a sheath pocket having a top 130 and a bottom 132 made of a flexible, resilient material that blocks contaminants from reaching the hand-held controller device, and wherein the hand-held controller device is disposed inside the sheath pocket: a passage through an open end 114 of the sheath that facilitates insertion of the hand-held controller device inside the sheath pocket, the open edge defining bottom passage edge 132 and a top passage edge 130, the top passage edge having holes 138 provided therein; and a sealing device 122 that closes the passage after the hand-held controller device has been inserted into the sheath portion; wherein the sealing device is disposed on the bottom passage edge 132 and the sealing device having an adhesive material 142 provided thereon for sealing with the top passage, the holes facilitating extrusion of a portion of the adhesive through the holes.

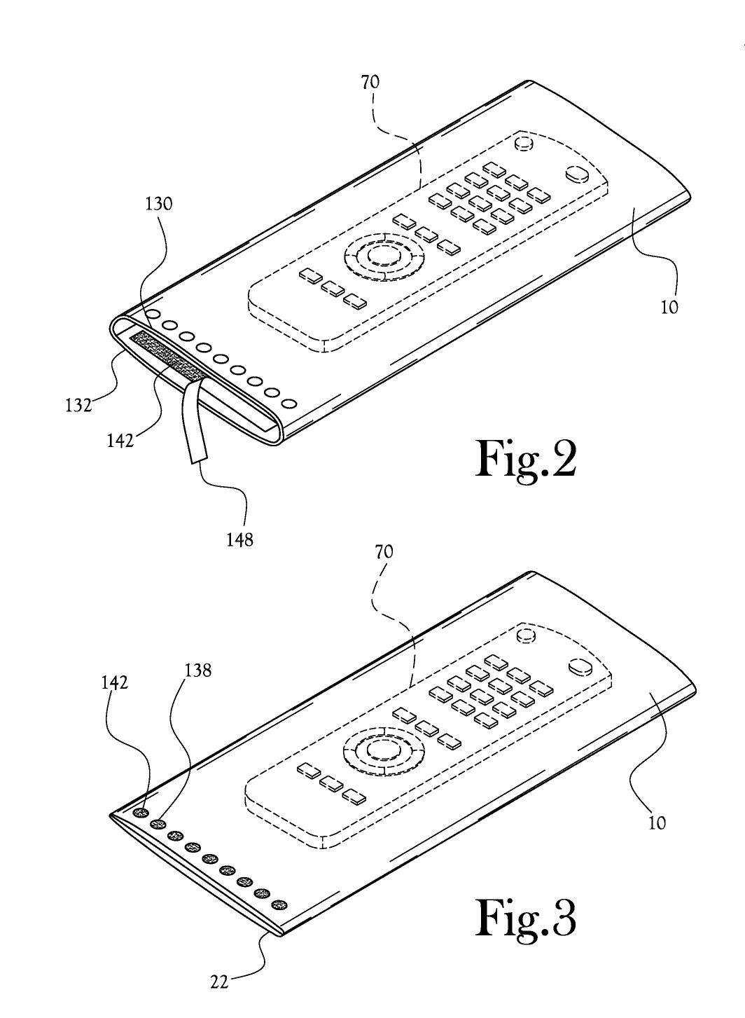

In an example embodiment illustrated in FIG. 2, the sealing device 122 is comprised of an adhesive strip having a carrier 148 that is removed or peeled off the adhesive strip to expose adhesive material on the adhesive strip.

In an example embodiment illustrated in FIG. 3, adhesive is extruded or pressed through the holes when the top edge 130 of the shield is pressed against the bottom edge 132 after the controller device is inserted into the shield pouch.

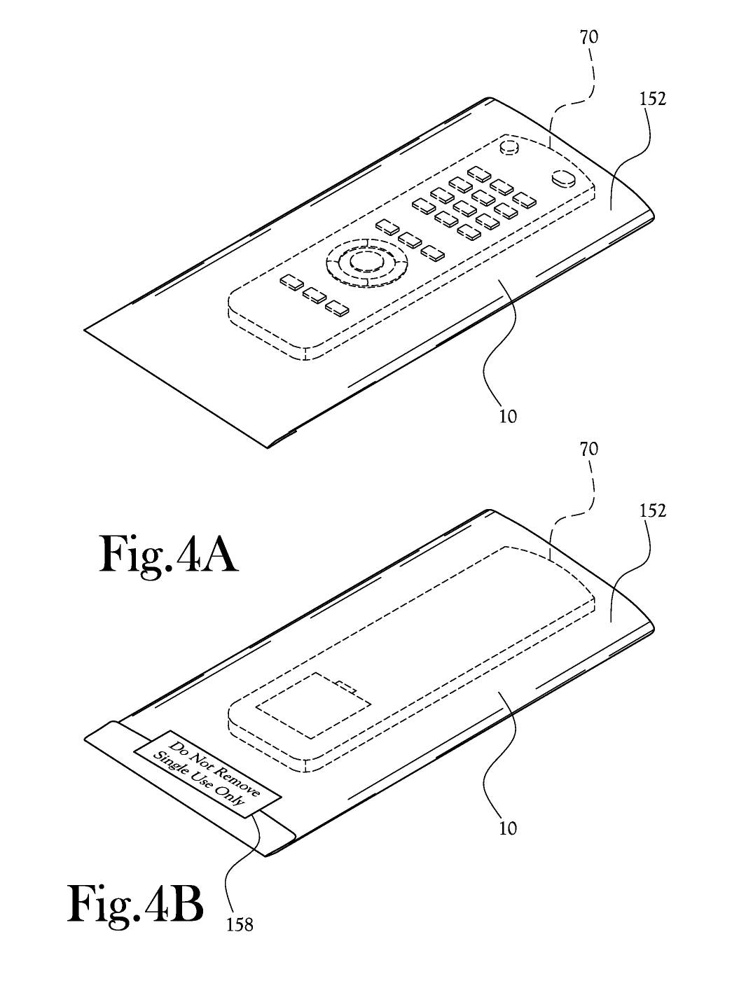

In an example embodiment illustrated in FIG. 4, adhesive is extruded or pressed through the holes when the top edge 130 of the shield is pressed against the bottom edge 132 after the controller device or remote 70 is inserted into the shield pouch.

The end portion 22 of the shield is folded over toward the top or closed end 152 of the shield wherein the folded portion of the shield is pressed onto the top of the shield and the adhesive that was extruded through the holes 138 adheres to the top of the shield. In an embodiment the folded portion seals the controller device in the shield pouch. Generally, as shown in FIGS. 4A and 4B, the hand-held controller device or remote 70 is inserted into the sheath or shield 10 in such a way that, when the end portion 22 is folded and brought into contact with the top or closed end 152 of the sheath or shield 10, the end portion 22 and top or closed end 152 are on the same side of the assembly as the “back” of the remote 70, and the “front” of the remote 70 (i.e., the surface containing the plurality of controls 72, 74 thereon) is facing in a direction away from the folded end portion 22.

In some embodiments, a label 158 may be disposed on the folded portion after it is sealed to indicate the controller device has been sealed in the shield pouch.

In an example embodiment, the label is removed before controller usage, the end of the shield pouch is opened, the controller device is removed from the shield and the shield is discarded for a one time use.

In an example embodiment, the shield may protect the controller device from biological contamination, such as bacteria or viruses.

In an example embodiment, the shield has a portion with a shape that generally matches the shape or size of the controller device. The shield forms a pocket with an open end through which the controller device is inserted. All other ends or sides of the shield are sealed.

The material used to form the shield may be any material that allows the sheath portion to fit around the controller device. An example material may be flexible enough to allow controls to be operated through the shield itself while preventing direct contact between the controls and any potential contaminants on the operator.

In an example embodiment, the shield material is resilient so that it may be stretched around the controller device as the controller device is inserted into the sheath portion while still being able to conform itself around the controller device. Possible shield materials include, but are not limited to, polyurethane, vinyl, latex, nitrile, or any other materials having similar resilient properties. In one embodiment, the shield is made of a synthetic material.

In an example embodiment, the shield is comprised of two generally rectangular pieces of material which are sealed together along three of the four edges of each respective piece of material. Example sealing techniques may be by heat, adhesive, vacuum, pressure, etc.

In an example embodiment, the shield has an open end 114 of a bi-directional passage through which the controller device may be inserted and removed. Although the illustrated embodiment shows an open edge having the same width as the widest portion of the controller device, the material used for the shield 10 may be resilient enough to allow the open edge to be narrower than the controller device.

An example enclosure for shielding a controller device may be removed and discarded after each use, yet allows a full range of functional capability of such device/equipment.

FIGS. 1-4 illustrate an embodiment wherein the open edge of the shield may be sealed by an adhesive tape, clamp, or other sealing device 122. Regardless of the specific sealing device used, it should maintain the integrity of the seal around the controller device. In an embodiment, the controller may be removed from the shield through the same passage 115 that it was inserted. In an embodiment, the shield may be removed by cutting or rupturing the shield to prevent biological contaminants on the shield surface to contact the controller device.

FIG. 2 illustrates a plan view of an embodiment shield having an adhesive tape attached to a backing, such as a paper or plastic backing The backing prevents the seal from adhering to the controller device or anything else so that the controller device may be inserted easily into the shield. Once the controller device is inserted into the shield, the backing may be peeled off to allow the sealing device to be attached to shield after folding or rolling the shield to form an additional seal of the shield and sealing the shield onto itself. In an embodiment, the sealing device is an adhesive strip that may be peeled off the backing and wrapped around the shield.

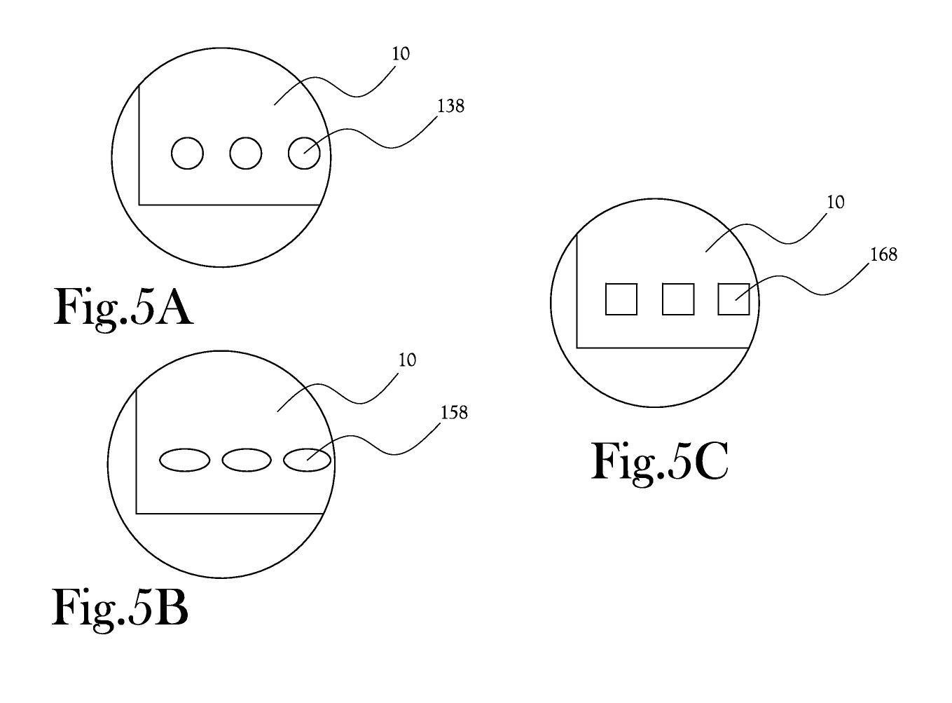

FIGS. 5A-5C illustrate example holes 138 having different shapes, such as circular 138, elliptical 158, square 168, etc.

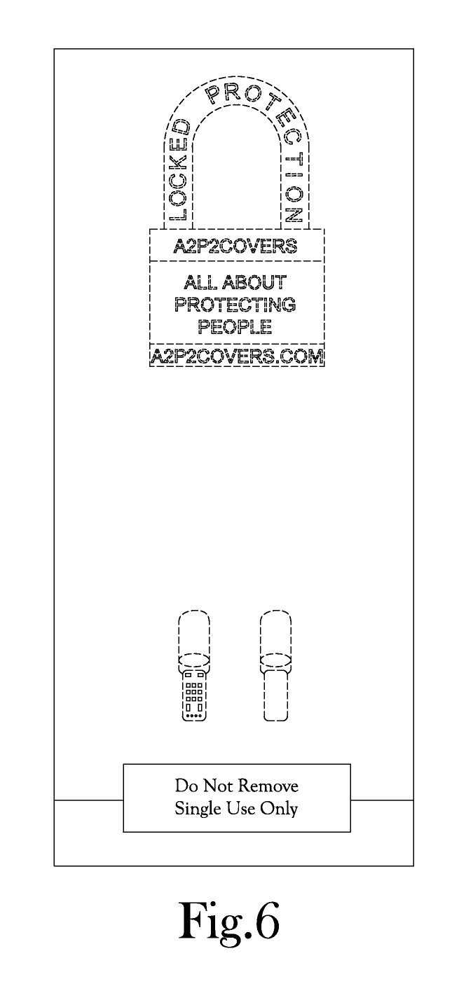

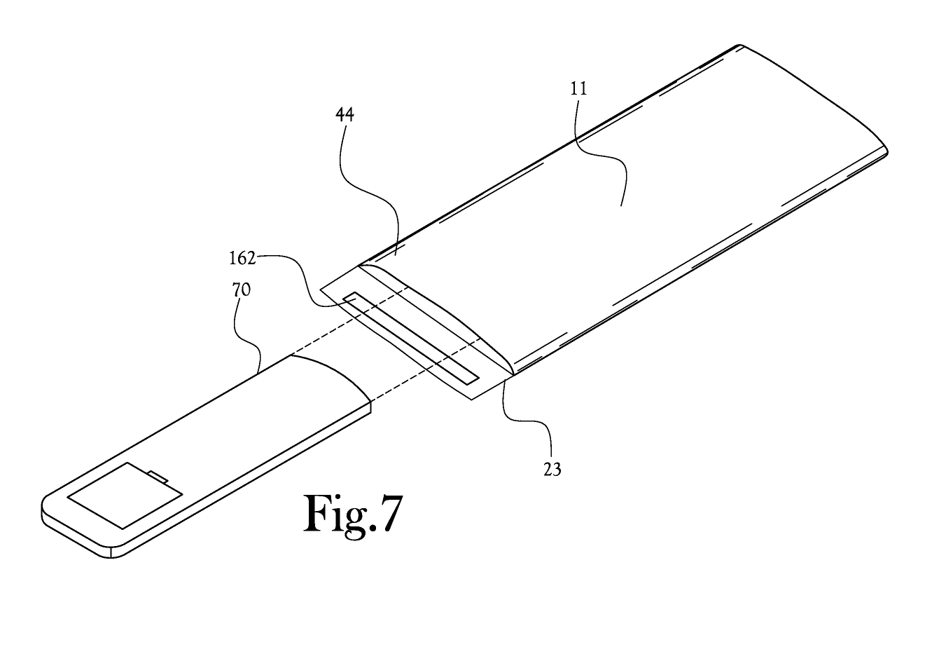

FIG. 6 illustrates an example embodiment of the present general inventive concept in which an embodiment shield includes advertisements, instructional text, or both printed onto the body of the shield.

In some embodiments, the sealing device includes an adhesive strip having a carrier that is removed or peeled off the adhesive strip to expose the adhesive material disposed on the adhesive strip, and the adhesive strip resides on a tab that extends from the bottom passage edge, said tab to be folded to bring the adhesive strip into contact with the top passage edge.

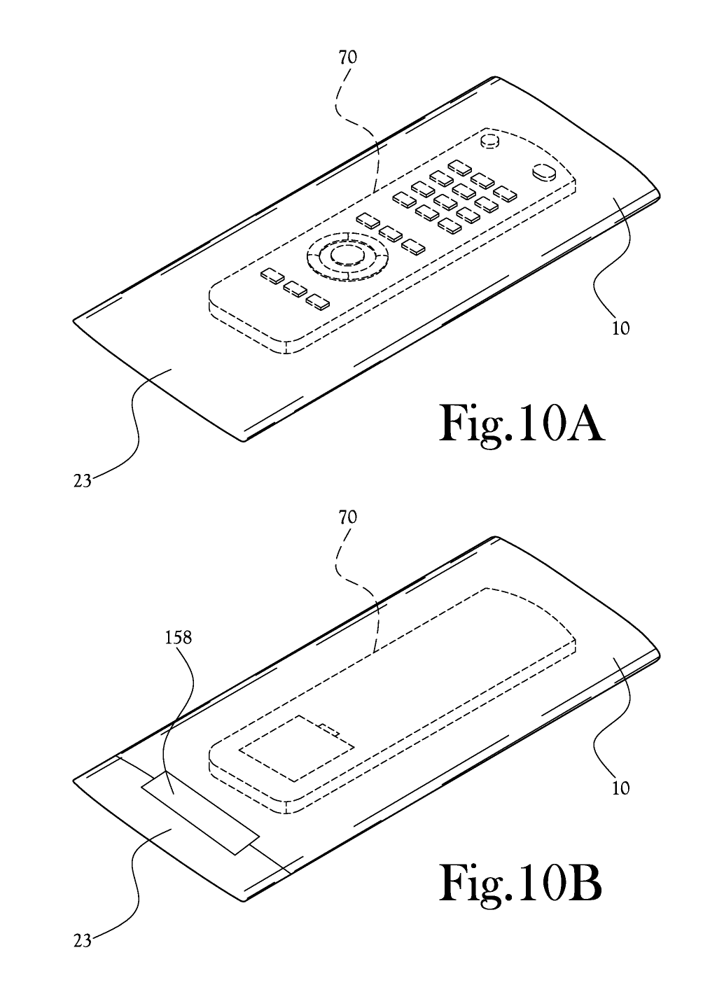

Turning to the FIG. 7, in one example embodiment of the present general inventive concept, a sheath or shield 11 of flexible material is disclosed for covering a hand-held controller device or remote 70 having a plurality of controls 72, 74 thereon which require manipulation by an operator for utilization of the device 70. The sheath 11 includes a tab 23 that extends from the open end 40 of the sheath 11. In the illustrated example embodiment, the tab 23 includes an adhesive covered by a protective strip 162. In use, after the hand-held controller device 70 has been inserted into the sheath 11, the protective strip 162 on the tab 23 is pulled away to expose the adhesive material 164. The tab 23 is then folded, as shown in FIG. 9, to bring the tab 23 and the adhesive material 164 into contact with the end portion of the opposing segment 44 of the sheath 11, whereby the sheath 11 is now sealed on along all four edges. Generally, the hand-held controller device or remote is inserted into the sheath 11 in such a way that, when the tab 23 is folded and brought into contact with the aforementioned segment 44 of the sheath 11, the tab 23 and segment 44 are on the same side of the assembly as the “back” of the remote 70, and the “front” of the remote 70 (i.e., the surface containing the plurality of controls 72, 74 thereon) is facing in a direction away from the tab 23. FIG. 10A is shows the hand-held controller device within the cover with the top side of the remote visible (and hence with the keys of the keypad visible); FIG. 10B illustrates the hand-held controller device or remote within the cover with the bottom side of the remote showing, displaying the folded tab. (In some embodiments, including the illustrated example embodiment shown in FIG. 10B, a label 158 is to be disposed on the folded tab 23 after it is sealed to indicate the controller device 70 has been sealed within the sheath 11.)

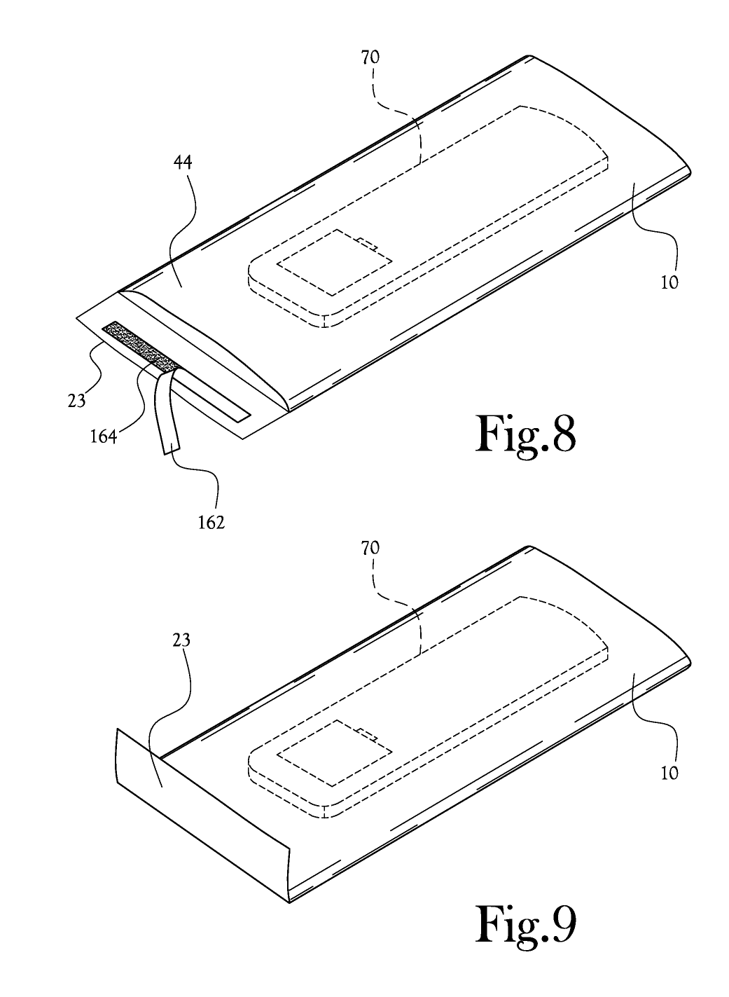

As with several other example embodiments as discussed above, the sheath or shield 11 illustrated in FIGS. 7-10 is made of a flexible, resilient material that blocks contaminants from reaching the hand-held controller device, and wherein the hand-held controller device is disposed inside the sheath.

An example embodiment shield structure blocks contaminants from being trapped on or inside a controller device, reducing the risks of cross-contamination when the units are handled by multiple people. The shield protects the controller device itself by blocking contaminants from entering the controller device and damaging the circuitry and preventing harsh fluids, such as cleaning solvents, from damaging the exterior case of the controller device. The shield may be disposable and changed as needed to keep the controller device clean. An example shield may be customized so that it may be precisely fit any particular controller device and different shields may be used for different devices.

An example embodiment shield or enclosure may be rectangular open ended box made by thermoforming from an extruded thermoplastic sheet which, upon heating, may be drawn into a mold cavity by a vacuum, e.g., so that the heated sheet assumes the shape determined by the contours of the cavity. Thermoforming processes are well-known to those skilled in the art, which procedures may be adapted for manufacturing the subject enclosure and, therefore, further details of such processes, in general, are not herein described. Suitable nonlimiting materials that may be used within the scope of the invention include ABS, polycarbonate, polystyrene, polyethylene and PETG (polyethylene terephthalate glycol). The height of the box may be on the order of 1.75 inches, the width on the order of 3 inches, and length on the order of 10 inches, or large enough to house a controller device.

An example embodiment enclosure may be regarded as “rigid,” inasmuch as, although it may flex upon application of a force during handling, in view of the relative small thickness of its parts, it nevertheless retains its shape. This rigidity is in contrast, e.g., to a so-called “shapeless” bag. The thickness of the materials may range from 0.005 inches to 0.010 inches, or from about 0.005 inches to about 0.010 inches.

Shields, sheaths, and protective enclosures for controller devices according to the present general inventive concept are useful, for example, in the hotel industry; there, the use of such devices and materials can help to minimize cross-guest contamination.

While embodiments are described herein, it is not the intention of the applicant to restrict or in any way limit the scope of the appended claims to such detail. Additional modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, what is claimed is:

1. An enclosure for protecting a hand-held controller device and for protecting individual user, comprising:
a shield including:
a sheath forming a sheath pocket having a top, a bottom, an open end and a closed end made of a flexible, resilient material that blocks contaminants from reaching the hand-held controller device and user, and wherein the hand-held controller device is disposed inside the sheath pocket;
a passage through the open end of the sheath to facilitate insertion of the hand-held controller device inside the sheath pocket, the open edge defining a bottom passage edge and a top passage edge; and
a sealing device that closes the passage after the hand-held controller device has been inserted into the sheath portion;
wherein the sealing device is disposed on the bottom passage edge for sealing with the top passage edge.

2. An enclosure according to claim 1, wherein the sealing device includes an adhesive strip having a carrier that is removed or peeled off the adhesive strip to expose the adhesive material disposed on the adhesive strip.

3. An enclosure according to claim 2, wherein said adhesive strip resides on a tab that extends from the bottom passage edge, said tab to be folded to bring the adhesive strip into contact with the top passage edge.

4. An enclosure according to claim 2, wherein the adhesive material is extruded or pressed through holes in an edge of the top passage.

5. An enclosure according to claim 4, wherein the adhesive material is extruded or pressed through the holes when the top passage edge is pressed against the bottom passage edge after the controller device is inserted into the sheath pouch, the open end of the sheath is folded over toward the closed end wherein the folded portion of the sheath is pressed onto the top of the sheath and the adhesive material that was extruded through the holes adheres to the top of the sheath

6. An enclosure according to claim 5, wherein the folded portion seals the controller device in the sheath pocket.

7. An enclosure according to claim 5, further comprising a label disposed on the folded portion to indicate the controller device has been sealed in the sheath pocket.

8. An enclosure according to claim 1, wherein the shield is discarded after the controller device is removed for a individual use of the shield.

9. An enclosure according to claim 1, wherein the shield protects the controller device and individual user from biological contamination.

10. A protective shield for protecting a controller device and user of the controller device from biological contamination comprising:
a sheath forming a sheath pocket having a top, a bottom, an open end and a closed end made of a flexible, resilient material that blocks contaminants from reaching the hand-held controller device and user, wherein the hand-held controller device is disposed inside the sheath pocket;
a passage through the open end of the sheath facilitating insertion of the controller device inside the sheath pocket, the open edge defining a bottom passage edge and a top passage edge; and
a sealing device that closes the passage after the controller device has been inserted into the sheath portion, the sealing device including an adhesive strip having a carrier that is removed or peeled off the adhesive strip to expose the adhesive material disposed on the adhesive strip;
wherein the sealing device is disposed on the bottom passage edge for sealing with the top passage edge.

11. A protective shield according to claim 10, wherein the sealing device includes an adhesive strip having a carrier that is removed or peeled off the adhesive strip to expose the adhesive material disposed on the adhesive strip.

12. A protective shield according to claim 11, wherein said adhesive strip resides on a tab that extends from the bottom passage edge, said tab to be folded to bring the adhesive strip into contact with the top passage edge.

13. A protective shield according to claim 10, wherein the adhesive material is extruded or pressed through the holes when the top passage edge is pressed against the bottom passage edge after the controller device is inserted into the sheath pouch.

14. A protective shield according to claim 10, wherein the adhesive material is extruded or pressed through the holes when the top passage edge is pressed against the bottom passage edge after the controller device is inserted into the sheath pouch, the open end of the sheath is folded over toward the closed end wherein the folded portion of the sheath is pressed onto the top of the sheath and the adhesive material that was extruded through the holes adheres to the top of the sheath

15. A protective shield according to claim 14, wherein the folded portion seals the controller device in the sheath pocket.

16. A protective shield according to claim 14, further comprising a label disposed on the folded portion to indicate the controller device has been sealed in the sheath pocket.

17. A protective shield according to claim 10, wherein the shield is discarded after the controller device is removed for individual use of the shield.
